(19) United States
(12) Patent Application Publication
(10) Pub. No.: US 2015/0339783 A1
(43) Pub. Date: Nov. 26, 2015

(54) Integrated system for calculating savings at several stages of procurement cycle by auto-fetching spend data into savings tracker system

(71) Applicants: BIKASH MOHANTY, MUMBAI (IN); ASHISH MOHAN JHA, MUMBAI (IN); PRASAD NAIR, MUMBAI (IN)

(72) Inventors: BIKASH MOHANTY, MUMBAI (IN); ASHISH MOHAN JHA, MUMBAI (IN); PRASAD NAIR, MUMBAI (IN)

(21) Appl. No.: 14/815,975

(22) Filed: Aug. 1, 2015

Related U.S. Application Data
(63) Continuation-in-part of application No. 13/939,005, filed on Jul. 10, 2013, now abandoned.

(30) Foreign Application Priority Data
Feb. 27, 2013 (IN) 567/MUM/2013

(51) Int. Cl. G06Q 40/00

(52) U.S. Cl. CPC G06Q 40/12

(57) ABSTRACT

An integrated system and method is described for calculating savings at several stages of the procurement cycle by auto-fetching spend data into a savings tracker system. The system includes: an integrated spend data input system adapted for auto-fetching of baseline spend data from a respective integrated system at each stage of the procurement cycle; a savings computing system adapted for computing savings at several stages of the procurement cycle by comparing auto-fetched baseline spend data and spend information at each stage of the procurement cycle by general formula: (auto-fetched baseline spend data)−(spend data at a specific stage of the procurement cycle)=(savings at the respective stage of the procurement cycle); and a display system adapted for displaying savings at the respective stages of the procurement cycle.

### CROSS-REFERENCE TO RELATED APPLICATION

The instant application is a continuation in part of U.S. patent application Ser. No. 13/939,005, filed Jul. 10, 2013, pending, and claims priority to Indian Patent Application Serial No. 567/MUM/2013, filed Feb. 27, 2013, the entire specifications of both of which are expressly incorporated herein by reference.

### FIELD OF THE INVENTION

The present invention relates generally to electronic procurement, and more particularly, to calculating savings by auto-fetching spend data. The present invention discloses an integrated system and a method for calculating savings at several stages of the procurement cycle by auto-fetching spend data into a savings tracker system.

### BACKGROUND OF THE INVENTION

Once procurement professionals decide on which goods to buy, a sourcing project for the good is typically launched. The sourcing project may have multiple stages and savings and may be reported across each stage until the time of buying. These stages could be: potential stage; negotiated stage; contract stage; implemented stage; or realized stage. The challenge is how to estimate spend data (e.g., baseline spend) at each stage to calculate the savings by comparing baseline spend and actual spend. Generally, at each of these stages, savings are calculated by providing spend data manually.

Accordingly, there exists a need for new and improved systems and methods for electronic procurement of goods that overcome at least one of the aforementioned disadvantages.

### SUMMARY OF THE INVENTION

The present invention provides an advantage by introducing an integrated system and a method for calculating savings at several stages of the procurement cycle by auto-fetching spend data into a savings tracker system. This baseline spend data may be fetched automatically from different systems, e.g., a spend management system, a database of contracts of suppliers, an auction and bids information system, or an e-procurement system, all of which may be integrated with the savings tracker system at each different stage of the procurement cycle.

An object of the present invention is to provide integrated systems and methods for calculating savings at several stages of the procurement cycle by auto-fetching spend data into the savings tracker system.

Another object of the present invention is to provide systems and methods for auto-fetching of the baseline spend data from different systems, e.g., a spend management system, a database of contracts of suppliers, an auction and bids information system, or an e-procurement system, all of which may be integrated with the savings tracker system at each different stage of the procurement cycle.

In accordance with one embodiment of the present invention, a system is provided containing an integration of several systems for calculating savings at several stages of the procurement cycle by auto-fetching spend data into the savings tracker system, the system comprising:

a processor unit; and

a computer readable medium storing instructions executable by the processor unit comprising:

an integrated spend data input system adapted for auto-fetching of the baseline spend data from the respective system;

a savings computing system adapted for computing savings at several stages of the procurement cycle by comparing the auto-fetched baseline spend and spend at each stage of the procurement cycle by the general formula:

(auto-fetched baseline spend)−(spend at the specific stage of the procurement cycle)=(savings at the respective stage of the procurement cycle); and

a display system adapted for displaying savings at the respective stages of the procurement cycle.

In accordance with another embodiment of the present invention, an integrated system for calculating savings at several stages of a procurement cycle by auto-fetching spend data into a savings tracker system is provided, comprising:

a host computer system;

at least one database component operably associated with the host computer system;

a communication interface for accessing the host computer system from a plurality of remote input/output devices;

a processor unit operably associated with the host computer system; and

a computer readable medium storing instructions executable by the processor unit, the computer readable medium comprising:

an integrated spend data input system adapted for auto-fetching of baseline spend data from a respective integrated system at each stage of the procurement cycle;

a savings computing system adapted for computing savings at several stages of the procurement cycle by comparing auto-fetched baseline spend data and spend information at each stage of the procurement cycle by general formula:

(auto-fetched baseline spend data)−(spend data at a specific stage of the procurement cycle)=(savings at the respective stage of the procurement cycle); and

a display system adapted for displaying savings at the respective stages of the procurement cycle.

In accordance with an aspect of this embodiment, the system further comprises any one of:

an integration of a spend data management system;

an auction and bids information system;

a database of contracts of suppliers; and

an e-procurement system.

In accordance with an aspect of this embodiment, the several stages of the procurement cycle include any one of a potential stage, negotiated stage, contract stage, implemented stage and realized stage.

In accordance with an aspect of this embodiment, when the specific procurement stage entered or activated into the savings tracker system, the system recognizes the specific procurement stage and activates the respective integrated system to provide the requisite auto-populated baseline information based on the pre-configured decision rules.

In accordance with an aspect of this embodiment, the pre-configured decision rules are responsible for triggering the respective integrated system upon entering a set of words into the savings tracker system to denote a starting of a specific procurement stage.

In accordance with an aspect of this embodiment, the baseline spend data at a potential stage is auto fetched or obtained from the spend data management system integrated with the savings analysis system, wherein the potential or forecasted savings is calculated by the formula:

(auto-fetched baseline spend data)−(potential or forecasted spend data)=potential or forecasted savings.

In accordance with an aspect of this embodiment, a user presets for auto fetching of spend data of a specific year as a baseline spend data at the potential stage based on a pre-configured decision rule.

In accordance with an aspect of this embodiment, the baseline spend data at the negotiated stage is auto fetched or obtained from the auction and bids information system, integrated with the savings analysis system, wherein the negotiated savings is calculated by the formula:

(auto-fetched baseline spend data)−(negotiated spend data)=negotiated savings.

In accordance with an aspect of this embodiment, a user presets for auto fetching of a specific bidder's information as the baseline spend data at the negotiated stage based on a pre-configured decision rule.

In accordance with an aspect of this embodiment, the baseline spend data at the implemented stage is auto fetched or obtained from the database of contracts of suppliers, integrated with the savings analysis system, wherein the implemented savings at the implemented stage is calculated by the formula:

(auto-fetched baseline spend data)−(implemented spend data)=implemented savings.

In accordance with an aspect of this embodiment, a user presets the auto-fetching or auto-populating of a specific supplier's contract price information as the baseline spend data at the implemented stage based on a pre-configured decision rule.

In accordance with an aspect of this embodiment, the e-procurement system provides the auto-fetched baseline spend data at the realized stage, wherein the realized savings is calculated by the formula:

(auto-fetched baseline spend data)−(realized spend data)=realized savings.

In accordance with an aspect of this embodiment, a user presets the auto-fetching of a specific supplier's invoice data as the baseline spend data at the realized stage based on a pre-configured decision rule.

In accordance with still another embodiment of the present invention, a method for calculating savings at several stages of a procurement cycle by auto-fetching spend data into a savings tracker system is provided, comprising the steps of:

providing a host computer system;

providing at least one database component operably associated with the host computer system;

providing a communication interface for accessing the host computer system from a plurality of remote input/output devices;

providing a processor unit operably associated with the host computer system; and

providing a computer readable medium storing instructions executable by the processor unit to perform the steps of:

auto-fetching the spend data from a respective system of an integrated system;

computing savings at several stages of the procurement cycle by comparing auto-fetched baseline spend data and spend data at each stage of the procurement cycle by the general formula:

(auto-fetched baseline spend data)−(spend data at a specific stage of the procurement cycle)=(savings at the respective stage of the procurement cycle); and

displaying savings at the respective stages of the procurement cycle.

In accordance with an aspect of this embodiment, the step of computing savings is calculated by any one of an integration of a spend data management system, an auction and bids information system, a database of contracts of suppliers and an e-procurement system.

In accordance with an aspect of this embodiment, the step of computing savings at the several stages of the procurement cycle includes any one of a potential stage, a negotiated stage, a contract stage, an implemented stage and a realized stage.

In accordance with an aspect of this embodiment, the step of computing potential or forecasted savings involves obtaining the auto-fetched baseline spend data at the potential stage from the spend data management system, wherein the potential/forecasted savings is calculated by the formula:

(auto-fetched baseline spend data)−(potential or forecasted spend data)=potential or forecasted savings.

In accordance with an aspect of this embodiment, the user selects the spend data of a specific year as a potential spend data based on a pre-configured decision rule.

In accordance with an aspect of this embodiment, the step of computing negotiated savings includes obtaining the auto-fetched baseline spend data at the negotiated stage from the auction and bids information system, wherein the negotiated savings is calculated by the formula:

(auto-fetched baseline spend data)−(negotiated spend data)=negotiated savings.

In accordance with an aspect of this embodiment, the user selects a specific bidder's information as a negotiated spend data based on a pre-configured decision rule.

In accordance with an aspect of this embodiment, the step of computing the implemented savings includes obtaining the auto-fetched baseline spend data at the implemented stage from the database of contracts of suppliers, wherein the implemented savings is calculated by the formula:

(auto-fetched baseline spend data)−(implemented spend data)=implemented savings.

In accordance with an aspect of this embodiment, the step of computing the realized savings involves obtaining the auto-fetched baseline spend data at the realized stage from the e-procurement system, wherein the realized savings is calculated by the formula:

(auto-fetched baseline spend data)−(realized spend data)=realized savings.

For example, the user could manage an element of the system and method for managing, analyzing and/or calculating savings at several stages of a procurement cycle by auto-fetching spend data into a savings tracker system on the handheld mobile device (e.g., cellular phone, smartphone, PDA, laptop computer, tablet computer, and/or any other like device that is selectively operable to communicate with the host computer system (or component thereof) through a wired and/or wireless connection) for which management, analysis and/or calculation needs to be done for.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a schematic showing an integrated system for savings calculation containing an integration of different systems;

FIG. 2 illustrates a schematic showing the different stages of the procurement cycle at which savings are to be calculated;

FIG. 3 illustrates a schematic showing the flow of spend data in the savings tracker system from other integrated systems at each different stage of the procurement cycle; and

FIGS. 4-12 illustrate several screen captures of the steps involved in a system for calculating savings by auto-fetching spend data from other integrated systems.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

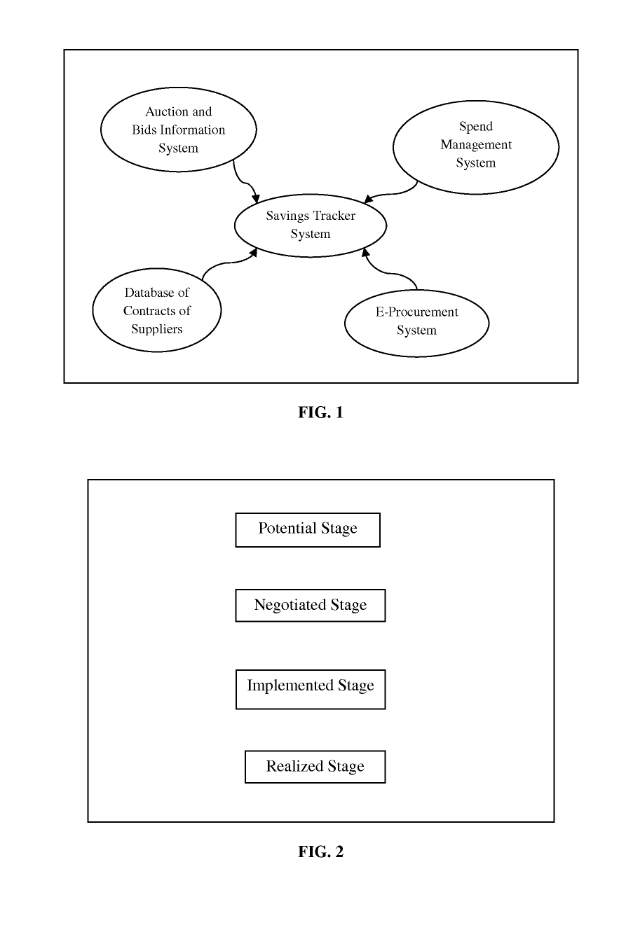

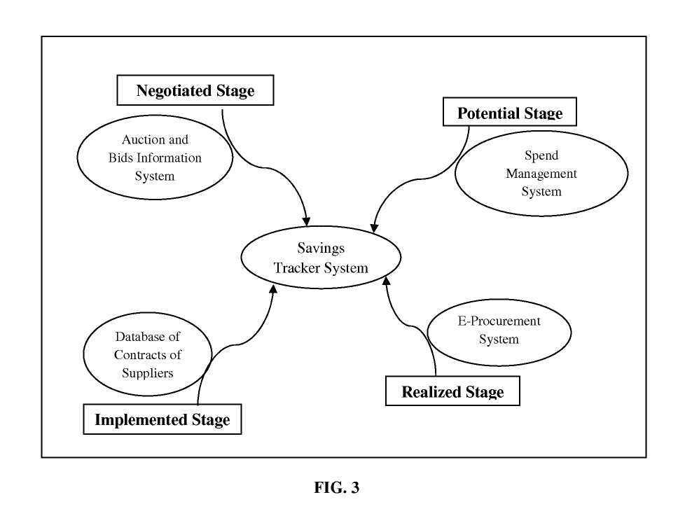

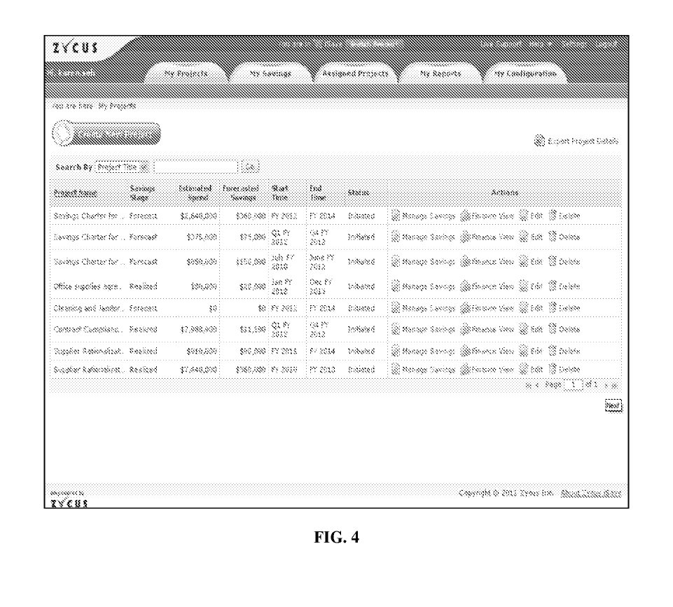

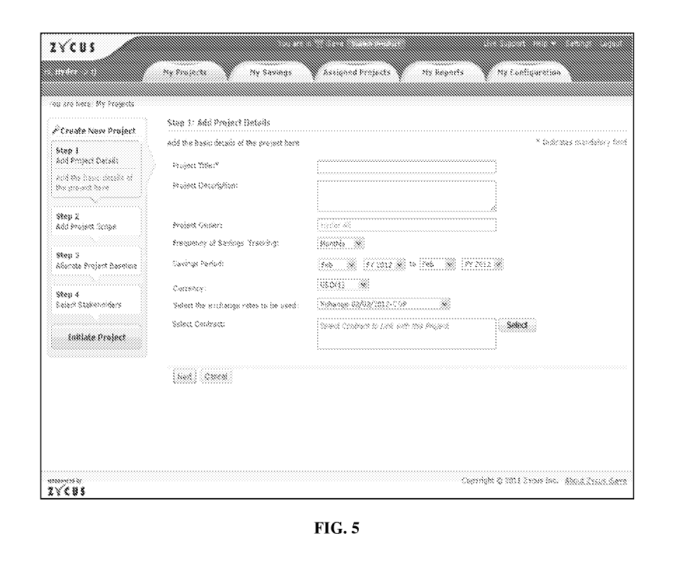

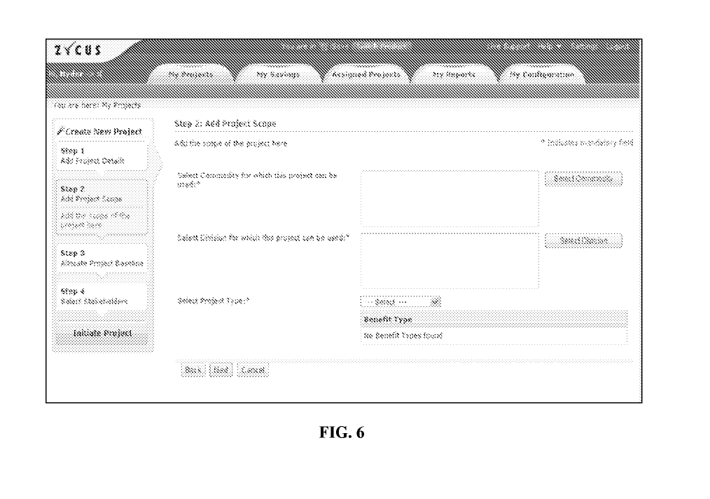

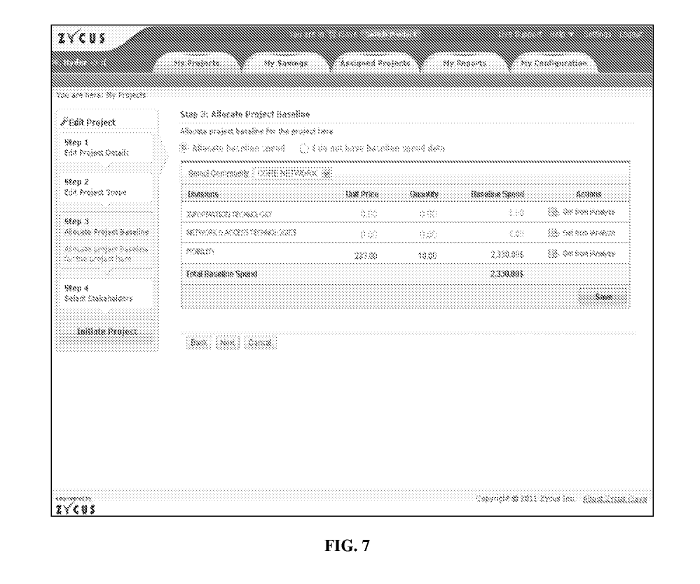

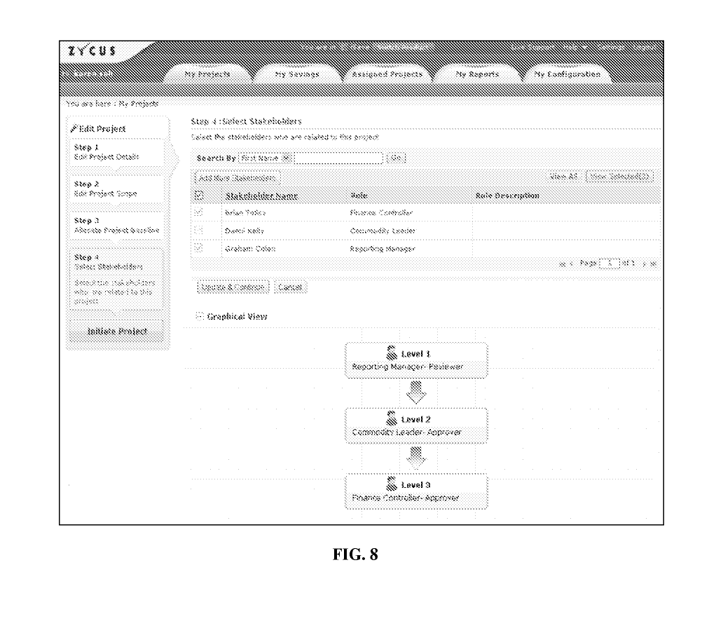

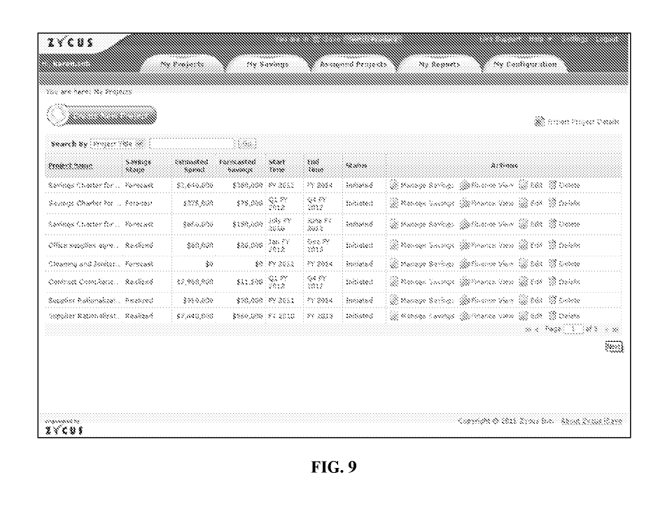

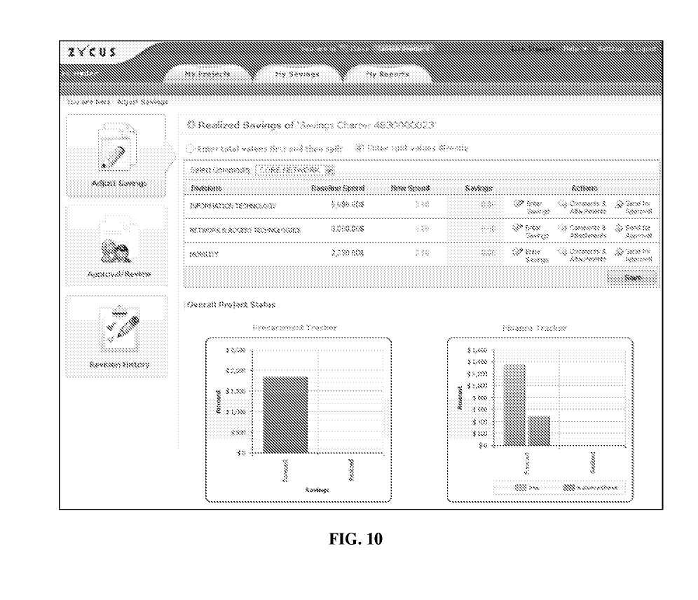

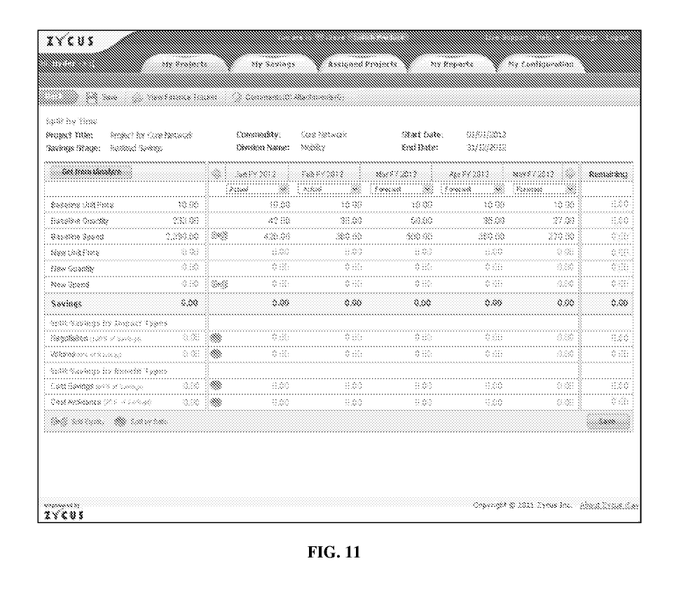

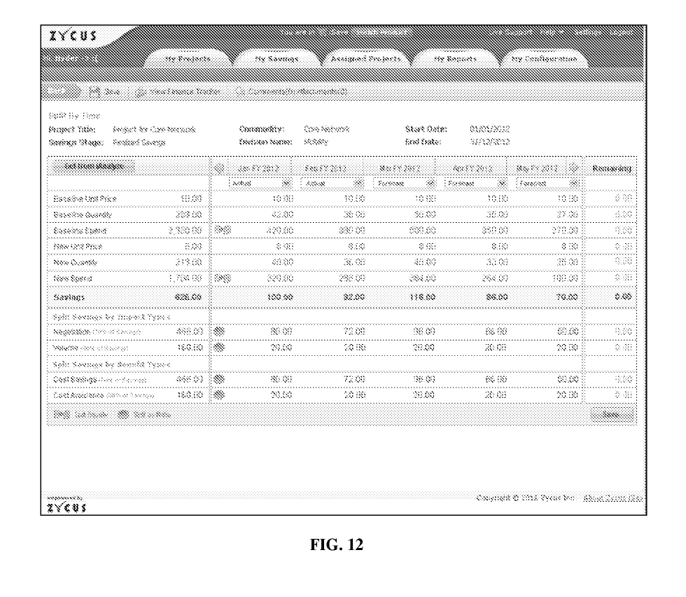

Referring to FIGS. 1-12, and according to an exemplary embodiment, a system is provided containing an integration of several systems for calculating savings at several stages of the procurement cycle by auto-fetching spend data into the savings tracker system, the system comprising:

a processor unit; and

a computer readable medium storing instructions executable by the processor unit comprising:

a spend data input system adapted for auto-fetching of spend data from the respective systems;

a savings computing system adapted for computing savings at several stages of the procurement cycle by comparing auto-fetched baseline spend and spend at each stage of the procurement cycle by general formula:

(auto-fetched baseline spend)−(spend at the specific stage of the procurement cycle)=(savings at the respective stage of the procurement cycle); and

a display system adapted for displaying savings at the respective stages of the procurement cycle.

According to an exemplary embodiment, the system contains an integration of a spend management system, an auction and bids information system, a database of contracts of suppliers, or an e-procurement system, with the saving tracker system.

According to another exemplary embodiment, the several stages of the procurement cycle may include potential stage, negotiated stage, contract stage, implemented stage, or realized stage. The potential stage of the procurement cycle is an initial stage of the procurement cycle where spends are forecasted and the savings at the potential stage are potential/forecasted savings. The negotiated stage is the stage where price negotiations are done by the buyer and spends are re-forecasted as per new price negotiations, and the savings at the negotiated stage are negotiated savings. While the implemented stage is a stage where the price of purchasing of the goods is finalized, and the savings at the implemented stage are implemented savings and the realized stage is a stage where the actual price is paid to the vendor, and the savings at the realized stage are realized savings.

According to yet another exemplary embodiment, when the specific procurement stage entered or activated into the savings tracker system, the system recognizes the specific procurement stage and activates the respective integrated system to provide the requisite auto-populated baseline information based on the pre-configured decision rule(s). These pre-configured decision rule(s) being responsible for triggering the respective integrated system upon entering set of words into the savings tracker system to denote starting of specific procurement stage. For example, the savings tracker system when the word negotiated stage is typed or any such synonym is typed into, there are pre-configured decision rules to recognize such words and upon recognition they trigger the activation of respective integrated system to fetch the auto baseline data.

According to yet another exemplary embodiment, these stages of the procurement cycle are mapped to several different systems, e.g., the spend management system, an auction and bids information system, a database of contracts of suppliers, and an e-procurement system, all of which may be adapted for gathering information automatically from these systems when the project reaches a respective stage, which further aids to forecast the spend and calculate savings.

According to still another exemplary embodiment, the spend data at a potential stage may be obtained from the spend management system. The system enables the user to select the spend data of a specific year as a potential spend based on pre-configured decision rules. The spend data at the negotiated stage may be obtained from the auction and bids information system. The system enables the user to select the specific bidder's information as the negotiated spend based on pre-configured decision rules. The database of contracts of suppliers may provide the spend data at the implemented stage which is an agreed contracted price for the item and the e-procurement system may provide the spend data at the realized stage which is invoiced spend data for the item.

According to another exemplary embodiment, the savings at each of these stages, e.g., potential stage, negotiated stage, contract stage, implemented stage and realized stage, may be calculated respectively by the formulae:

(auto fetched baseline spend)−(potential/forecasted spend)=potential/forecasted savings;

(auto fetched baseline spend)−(negotiated spend)=negotiated savings;

(auto fetched baseline spend)−(implemented spend)=implemented savings; or

(auto fetched baseline spend)−(realized spend)=realized savings.

By way of a non-limiting example, the feature flow of the system will be explained below.

The user, e.g., using a mobile device such as a cell phone, may indicate the procurement stage for which he/she wants to view the computed savings for that item. For example, at the negotiate stage, the user may want to see the procurement savings for the purchase of computers.

The system may be trained or programmed to recognize the user feed/input (e.g., “negotiate stage”) and, accordingly, the flipping engine may switch over from the existing integration module to the requisite electronic auction procurement module, with the savings tracker system fetching the baseline spend for that negotiate procurement stage.

The savings tracker system is preferably the main system with which various other procurement modules are embedded, such as, but not limited to spend module, electronic auction module, contract module, e-procurement module and/or the like. At any one point of time, the savings tracker system may remain integrated with any one embedded procurement module. For example, as the user feeds or keeps on changing one procurement stage input to another procurement stage input (e.g., if the user changes input from potential stage to negotiate stage), then the flipping engine present within the savings tracker system may switch the integration from one procurement module to another procurement module to fetch the baseline spend for that procurement stage.

For example, if the user inputs negotiate stage, then the system may flip the existing integration to the integration of the electronic auction module to fetch the auction and bids information as baseline spend information for that item. The savings analysis system, based on the auto fetched baseline information, may compute negotiated savings as calculated by the formula: (auto-fetched baseline spend)−(negotiated spend)=negotiated savings.

Once the baseline spend is auto-fetched, e.g., by flipping the integration with the requisite module, the next step is to calculate savings at different procurement stages.

A savings computing system may be adapted for computing savings at several stages of the procurement cycle by comparing auto-fetched baseline spend and spend information at each stage of the procurement cycle by the formula: (auto-fetched baseline spend)−(spend at a specific stage of the procurement cycle)=(savings at the respective stage of the procurement cycle). A display system may be adapted for displaying savings at the respective stages of the procurement cycle.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated system for calculating savings at several stages of a procurement cycle by auto-fetching spend data into a savings tracker system, comprising:
a host computer system;
at least one database component operably associated with the host computer system;
a communication interface for accessing the host computer system from a plurality of remote input/output devices;
a processor unit operably associated with the host computer system; and
a computer readable medium storing instructions executable by the processor unit, the computer readable medium comprising:
an integrated spend data input system adapted for auto-fetching of baseline spend data from a respective integrated system at each stage of the procurement cycle;
a savings computing system adapted for computing savings at several stages of the procurement cycle by comparing auto-fetched baseline spend data and spend information at each stage of the procurement cycle by general formula:
(auto-fetched baseline spend data)−(spend data at a specific stage of the procurement cycle)=(savings at the respective stage of the procurement cycle); and
a display system adapted for displaying savings at the respective stages of the procurement cycle.

2. The system according to claim 1, wherein the system further comprises any one of:
an integration of a spend data management system;
an auction and bids information system;
a database of contracts of suppliers; and
an e-procurement system.

3. The system according to claim 1, wherein the several stages of the procurement cycle include any one of a potential stage, negotiated stage, contract stage, implemented stage and realized stage.

4. The system according to claim 1, wherein, when the specific procurement stage entered or activated into the savings tracker system, the system recognizes the specific procurement stage and activates the respective integrated system to provide the requisite auto-populated baseline information based on the pre-configured decision rules.

5. The system according to claim 4, wherein the pre-configured decision rules are responsible for triggering the respective integrated system upon entering a set of words into the savings tracker system to denote a starting of a specific procurement stage.

6. The system according to claim 3, wherein the baseline spend data at a potential stage is auto fetched or obtained from the spend data management system integrated with the savings analysis system, wherein the potential or forecasted savings is calculated by the formula:
(auto-fetched baseline spend data)−(potential or forecasted spend data)=potential or forecasted savings.

7. The system according to claim 6, wherein a user presets for auto fetching of spend data of a specific year as a baseline spend data at the potential stage based on a pre-configured decision rule.

8. The system according to claim 3, wherein the baseline spend data at the negotiated stage is auto fetched or obtained from the auction and bids information system, integrated with the savings analysis system, wherein the negotiated savings is calculated by the formula:
(auto-fetched baseline spend data)−(negotiated spend data)=negotiated savings.

9. The system according to claim 8, wherein a user presets for auto fetching of a specific bidder's information as the baseline spend data at the negotiated stage based on a pre-configured decision rule.

10. The system according to claim 3, wherein the baseline spend data at the implemented stage is auto fetched or obtained from the database of contracts of suppliers, integrated with the savings analysis system, wherein the implemented savings at the implemented stage is calculated by the formula:
(auto-fetched baseline spend data)−(implemented spend data)=implemented savings.

11. The system according to claim 10, wherein a user presets the auto-fetching or auto-populating of a specific supplier's contract price information as the baseline spend data at the implemented stage based on a pre-configured decision rule.

12. The system according to claim 3, wherein the e-procurement system provides the auto-fetched baseline spend data at the realized stage, wherein the realized savings is calculated by the formula:
(auto-fetched baseline spend data)−(realized spend data)=realized savings.

13. The system according to claim 12, wherein a user presets the auto-fetching of a specific supplier's invoice data as the baseline spend data at the realized stage based on a pre-configured decision rule.

14. A method for calculating savings at several stages of a procurement cycle by auto-fetching spend data into a savings tracker system, comprising the steps of:
providing a host computer system;
providing at least one database component operably associated with the host computer system;
providing a communication interface for accessing the host computer system from a plurality of remote input/output devices;
providing a processor unit operably associated with the host computer system; and
providing a computer readable medium storing instructions executable by the processor unit to perform the steps of:
auto-fetching the spend data from a respective system of an integrated system;
computing savings at several stages of the procurement cycle by comparing auto-fetched baseline spend data and spend data at each stage of the procurement cycle by the general formula:
(auto-fetched baseline spend data)−(spend data at a specific stage of the procurement cycle)=(savings at the respective stage of the procurement cycle); and
displaying savings at the respective stages of the procurement cycle.

15. The method according to claim 14, wherein the step of computing savings is calculated by any one of an integration of a spend data management system, an auction and bids information system, a database of contracts of suppliers and an e-procurement system.

16. The method according to claim 14, wherein the step of computing savings at the several stages of the procurement cycle includes any one of a potential stage, a negotiated stage, a contract stage, an implemented stage and a realized stage.

17. The method according to claim 16, wherein the step of computing potential or forecasted savings involves obtaining the auto-fetched baseline spend data at the potential stage from the spend data management system, wherein the potential/forecasted savings is calculated by the formula:
(auto-fetched baseline spend data)−(potential or forecasted spend data)=potential or forecasted savings.

18. The method according to claim 17, wherein the user selects the spend data of a specific year as a potential spend data based on a pre-configured decision rule.

19. The method according to claim 16, wherein the step of computing negotiated savings includes obtaining the auto-fetched baseline spend data at the negotiated stage from the auction and bids information system, wherein the negotiated savings is calculated by the formula:
(auto-fetched baseline spend data)−(negotiated spend data)=negotiated savings.

20. The method according to claim 19, wherein the user selects a specific bidder's information as a negotiated spend data based on a pre-configured decision rule.

21. The method according to claim 16, wherein the step of computing the implemented savings includes obtaining the auto-fetched baseline spend data at the implemented stage from the database of contracts of suppliers, wherein the implemented savings is calculated by the formula:
(auto-fetched baseline spend data)−(implemented spend data)=implemented savings.

22. The method according to claim 16, wherein the step of computing the realized savings involves obtaining the auto-fetched baseline spend data at the realized stage from the e-procurement system, wherein the realized savings is calculated by the formula:
(auto-fetched baseline spend data)−(realized spend data)=realized savings.
